(19) United States
(12) Patent Application Publication
(10) Pub. No.: US 2016/0239931 A1
(43) Pub. Date: Aug. 18, 2016

(54) ENSURING PROGRAM INTEGRITY IN BENEFIT SYSTEMS

(71) Applicant: Maximus, Inc., Reston, VA (US)

(72) Inventors: Mohammad A. Sabri, Reston, VA (US); Joseph A. Dupelle, Reston, VA (US)

(21) Appl. No.: 15/011,032

(22) Filed: Jan. 29, 2016

Related U.S. Application Data
(60) Provisional application No. 62/110,521, filed on Jan. 31, 2015.

(51) Int. Cl. G06Q 50/26; G06Q 10/10; G06F 17/30

(52) U.S. Cl. CPC G06Q 50/26; G06F 17/30495; G06F 17/30528; G06Q 10/1057

(57) ABSTRACT

A method of ensuring program integrity in a benefit system includes accessing sets of data from two or more data sources. Data from at least one of the data sources relates to eligibility of a recipient to receive a benefit under a government program. Electronic data matching is performed using the data sources. The data sources used for the electronic data matching includes one or more government data sources and may include one or more commercial data sources. Results from the electronic data matching using two or more of the data sources are displayed in a consolidated view. Based on the electronic data matching, assessments are made relating to eligibility of the recipient. Based on the eligibility assessments, one or more recommendations are made regarding eligibility of the recipient.

### PRIORITY CLAIM

This application claims priority to U.S. Provisional Application Ser. No. 62/110,521 entitled “ENSURING PROGRAM INTEGRITY IN BENEFIT SYSTEMS” filed Jan. 31, 2015, which is incorporated herein by reference in its entirety.

### BACKGROUND

1. Field

The present invention relates to the field of services and systems that are used to provide government benefits. Embodiments of the invention relate to automation of third party data into a single worker portal, and systems, processes, and algorithms for making eligibility determinations.

2. Description of the Related Art

Government and business entities that provide benefits to consumers often rely on electronic data maintained in computer systems to process applications, determine and monitor eligibility, and control distribution of the benefits. In many cases, the information in the benefits system is used to continuously to make and carry out decisions on what benefits should be distributed, when, and to what recipients.

Many challenges arise in ensuring that correct information for determining eligibility and making proper distribution of benefits is available to decision makers using the benefits system. Data concerning applicants may be incorrect due to, for example, the wrong information being provided by the applicant (whether intentionally or unintentional) or another person, such as the staff of a service provider, or information that was omitted from the application process. Also, information in a system may become out of date, for example, because of a change in circumstances of the person receiving the benefit (income, residency, or other factor) that affects the eligibility of the person to receive the benefit.

Enrollees in Medicaid are required, for example, to report any change affecting their eligibility throughout the year of coverage. There is no guarantee, however, that the enrollees will actually report changes. Moreover, in some programs, fraud by participants may result in significant number of payments to ineligible recipients.

In some respects, the marketplace has effectively taken an “assess or determine and refer” approach to eligibility verification, relying on data that may include self-attested, unverified information. Significant numbers of inconsistencies arise among the self-reported information and the data pulled from other sources. For example, the Office of the

Inspector General of the U.S. Department of Health and Human Services has reported that 2.6 million of 2.9 million inconsistencies identified on the federal marketplace remained unresolved as of June 2014. These inconsistencies may pass down to state's programs. These inconsistencies introduce added cost in the form of covering potentially ineligible members. The inconsistencies also create a backlog that could prevent eligible consumers from receiving coverage and access to critical services when they need it.

In some cases, government regulations and/or functional limits of the benefits system or regulations may limit the ability of benefit providers to address out of date or incorrect information in their systems. Moreover, it may be difficult to even assess how effective the system is in determining the correct benefits, at the correct time, to the correct recipients, or delivering benefits based on such determinations.

### SUMMARY

Systems and methods for performing eligibility verifications and ensuring program integrity are disclosed. In one embodiment, a method of ensuring program integrity in a benefit system includes accessing sets of data from two or more data sources. The data from at least one of the data sources relates to eligibility of a recipient to receive a benefit under a government program. Electronic data matching is performed using the data sources. The data sources used for the electronic data matching include one or more government data sources and may include one or more commercial data sources. In some embodiments, the electronic data matching is performed by a data broker sub-system. Based on the electronic data matching, an assessment is made relating to eligibility of the recipient. Results from the electronic data matching using two or more of the data sources are displayed in a consolidated view. Based on the assessments, one or more recommendations may be made regarding eligibility of the recipient. In some embodiments, eligibility verifications made using the system are analyzed to assess program integrity.

In an embodiment, a system includes an eligibility verification module, a data broker module, and a document processing module. The data broker module accesses sets of data from two or more data sources. Data from the data sources relates to eligibility of a recipient to receive a benefit under a government program. A data broker module performs electronic data matching using the data sources. The data sources used for the electronic data matching include one or more government data sources and may include one or more government data sources. Results from the electronic data matching using two or more of the data sources may be displayed in a consolidated view. Based on the electronic data matching, eligibility determinations or assessments may be made relating to eligibility of the recipient. Based on the eligibility determinations, one or more recommendations are made regarding eligibility of the recipient.

In an embodiment, a method of ensuring program integrity in a benefit system includes accessing, by a data broker module, sets of data from two or more data sources. The data broker module performs electronic data matching using the data sources. Based on the electronic data matching, an assessment relating to eligibility of the recipient is made. Items of missing information relating to at least one recipient, wherein at least one of the missing items affects eligibility of the recipient. An information request is generated based on the data matching process and transmitting to the recipient.

In an embodiment, a method of ensuring program integrity in a benefit system includes accessing, by a data broker module, data sets from two or more data sources. The data broker module performs electronic data matching using the data sources. One or more inconsistencies are identified between the sets of data of different data types. Based on the electronic data matching, an assessment relating to eligibility of the recipient is made. A recommendation on eligibility of the recipient is made based at least in part on the inconsistencies between data in sets of data of different data types.

In an embodiment, a system for ensuring program integrity includes an eligibility verification system, implemented on one or more computing devices. The eligibility verification system is configured to implement: an electronic data matching module that performs electronic data matching on sets of data from multiple sources; and an intercept for account transfer objects that ensures, based at least in part on the data matching, that a benefit to a recipient is distributed in a manner consistent with information from the multiple data sources.

In an embodiment, a method of ensuring program integrity in a benefit system includes accessing, by a data broker module, sets of data from two or more data sources. The data from at least one of the data sources relates to eligibility of a recipient to receive a benefit under a government program. Electronic data matching is performed using the data sources. At least one of the data sources used in the electronic data matching is a government data source, and at least one of the data sources may be a commercial data source. A measure of program integrity is determined based on the electronic data matching by the data broker module.

### BRIEF DESCRIPTION OF THE DRAWINGS

FIG. 1 illustrates one embodiment of system for providing benefits to recipients under government program that includes an eligibility verification system with a data broker module.

FIG. 2 illustrates one embodiment of a passive renewal process that includes electronic data matching.

FIG. 3 illustrates one embodiment of performing an eligibility determination on selected clients between passive annual redeterminations.

FIG. 4 illustrates one embodiment of performing electronic data matching on selected clients for program integrity verification.

FIG. 5 illustrates one embodiment of performing electronic data matching in a premium assistance program.

FIG. 6 illustrates case creation/update and data match process in one embodiment of an eligibility verification system.

FIG. 7 illustrates data evaluation and eligibility determination in one embodiment of an eligibility verification system.

FIG. 8 illustrates document processing in one embodiment of an eligibility verification system.

FIG. 9 illustrates one embodiment of a cloud computing system that can be implemented to perform eligibility verification and assess program integrity.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF ILLUSTRATIVE EMBODIMENTS

### Program Integrity Assurance Platform with Data Matching From Multiple Commercial and Government Data Sources

In some embodiments, a platform for promoting program integrity performs electronic data matching using multiple data sources. The data matching is used to monitor and assess eligibility of persons receiving a government benefit. The eligibility assessment may be made for an initial eligibility determination, and/or after the initial determination on an ongoing basis or periodic basis (for example, passive renewal determinations, post-eligibility reviews). The system aggregates, validates, and analyzes data from multiple commercial or private data sources, including third party data brokers, as well as state and federal data sources. The assessment may include applying filters to provide information and trigger actions based on the information. In certain embodiments, a system cross-matches data from commercial data sources against government data sources.

In some embodiments, a single adapter is used to access numerous data sources. Disparate data sources may be consolidated into a single screen view. Errors and inconsistencies in a participant's application data or status may be identified. In some cases, inconsistencies between self-attested information and other information are identified.

The system may generate eligibility alerts and recommendations based on the data matching. Examples of programs for which eligibility can be determined and monitored include Medicare, Medicaid, Children's Health Insurance Program (CHIP), temporary assistance to needy families (TANF), unemployment insurance, or health insurance.

In some cases, the system identifies and manages missing information using the output of the data matching process. The system may perform outreach to participants to resolve incomplete information or inconsistencies.

In some cases, the system determines and assessing program integrity based on electronic data matching. Assessing program integrity may include assessments of the amount of incorrect or inconsistent data in a database of a system, in error rates of processes or actions performed using a system, or combinations thereof. A system may assess error rates in client records, rate of fraudulent claim activity, rates of incorrect eligibility determinations, rates of error in payments to recipients, or accuracy rates of error in records. In some cases, eligibility audit error rates are reduced by assessing positive and negative determinations made by the system.

### System for Ongoing Eligibility Determination with Automatic Outreach

In some embodiments, a system provides automatic outreach to participants in resolving inconsistencies, errors, and status changes relating to eligibility of participants receiving government benefits. The system performs data matching using multiple data sources to monitor and assess eligibility. The eligibility assessment is made on an ongoing basis, periodic basis (for example, annual eligibility redeterminations), or both. The data matching may combine and compare data from multiple commercial data sources, including third party data brokers, as well as state and federal data sources.

In some embodiments, a system identifies and manages missing information using the output of the data matching process. The system may perform outreach to participants to resolve incomplete information or inconsistencies. For example, the system may automatically generate letters or messages to program participants or others to supply missing information identified by the system. The system may also notify participants of changes to their eligibility status. In some cases, the system automatically determines whether a participant is eligible for a related or alternative program (when, for example, the system determines that the participant is no longer eligible for a particular program). In some cases, the system integrates contact center services for member outreach and inquiry responses.

### Eligibility Verification and Monitoring using Inconsistencies Inferred from Disparate Data Sources

In some embodiments, a system uses comparisons and relationships among different classes of data to infer inconsistencies, errors, or changes in status relating to eligibility of participants that are receiving government benefits. In some cases, the system draws inferences from relationships between explicit eligibility criteria (e.g., the participant asserts that they are a resident of the state from which the benefit is sought) and other information that is not explicitly related to program eligibility. For example, information for a commercial data sources indicating that a person is incarcerated in Tennessee or teaching college classes in New Hampshire may be inconsistent with receiving a benefit as a current resident of California. Similarly, a person receiving benefits based on low income in one state may be inconsistent with large bank accounts in another state. When inconsistencies are identified, the system may generate alerts or recommendations.

In some embodiments, a system automatically changes the status (e.g., discontinues a benefit) based on an identified inconsistency or error. Examples of records that can be monitored and used to identify inconsistencies for eligibility purposes include records relating to death (e.g., death certificates), incarceration, assets (e.g., deposit accounts), immigration, citizenship, public health, employment, taxes, state residency, and income.

In some cases, the system performs outreach to participants to resolve incomplete information, inconsistencies, or status changes.

In some embodiments, a system aggregates data from government and commercial third-party sources into a single view for simple decision making. These data sources are also used to monitor beneficiaries for changes in their eligibility profile. This allows states to promptly ensure members remain in their correct insurance program and mitigates the risk of churn for beneficiaries at the next redetermination point. When an inconsistency is identified, the eligibility determination system verifies the information and reaches out to beneficiaries to clear up inconsistencies. Through the system, outreach and reconciliation may be coupled another.

In some embodiments, electronic data matching is performed at predetermined intervals to check for new or changed enrollee information. New eligibility recommendations are generated if a possible change is detected.

In some embodiments, an eligibility verification system includes a single adapter that accesses numerous individual data sources. New electronic data sources may be integrated into the eligibility decision process without adding to administrative burden or modifying existing systems. Disparate data may be brought into one comprehensive Member view, expediting eligibility decisions and reducing administrative burden.

As further described below, an eligibility verification system, in various embodiments, manages workflow and missing information, letter generation and mailhouse support, document management and reporting.

The system as described herein may be used to promote program integrity by flagging questionable eligibility decisions for further investigation. In some embodiments, a review of negative determination decisions using the system is conducted to determine potentially incorrect decisions of ineligibility. Eligibility audit error rates may be reduced by assessing positive and negative determinations made using the system. Processing time of cases that require redeterminations and ensure that eligibility for Medicaid coverage may be periodically verified (e.g., on an annual basis). In certain embodiments, a stand-alone service and system operate in parallel to ongoing operations, with no integration between the ongoing operations and the service/system.

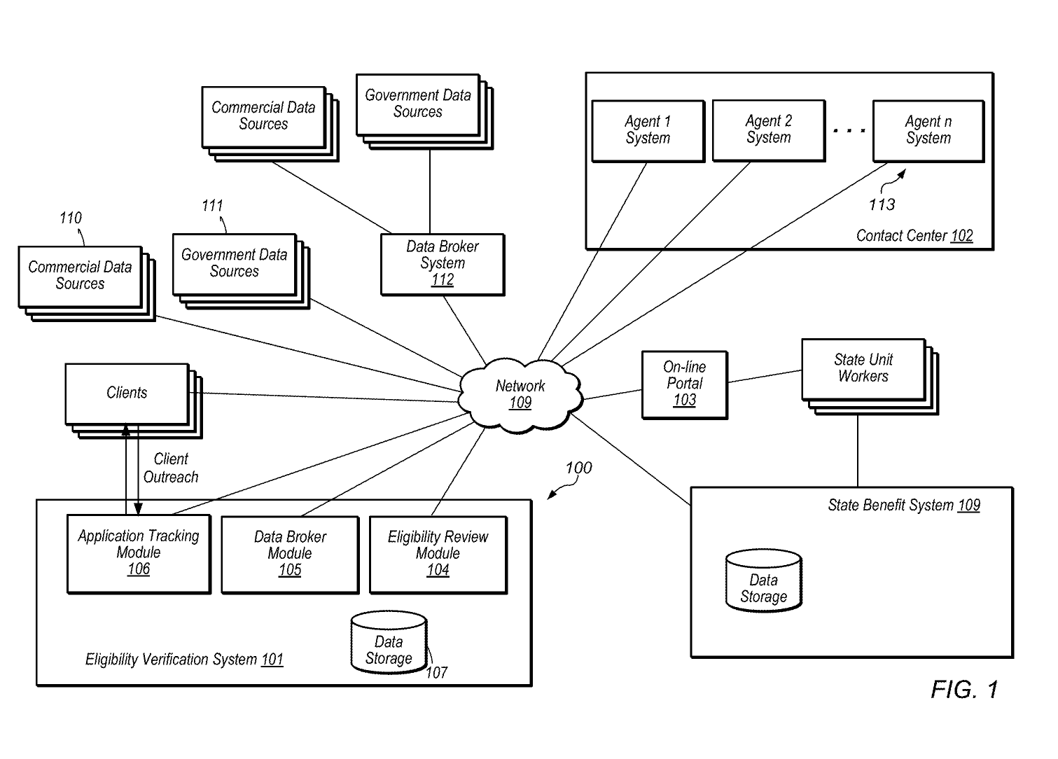

FIG. 1 illustrates one embodiment of a system for administering benefits that includes an eligibility verification system having a data broker module. System 100 includes eligibility verification system 101, contact center 102, and online portal 103. Eligibility verification system 101 includes eligibility review support module 104, data broker module 105, application tracking module 106, and data storage 107. Eligibility verification system 101 communicates with state benefit system 108 and contact center 102 by way of network 109.

Data broker module 106 may be used to establish composite client profiles based on data obtained from commercial and State based third party sources. In some embodiments, data broker module 105 performs data matching on commercial data sources 110 and government data sources 111 accessible via network 109. In certain embodiments, commercial and government is provided by way of an outside data broker system, such as data broker system 112. A dashboard may be provided for viewing data broker activity.

Data broker module 105 may access and perform data matching of data from commercial and government data sources, including data addressing various eligibility factors. Data sources may provide data on clients including the following:
Quarterly wages
Monthly wages
New hires
Paystub information via The Work Number
Unemployment Benefits
SSA-BENDEX
Citizenship verification and SSN verification
DMV
Equifax (address & phone info)
State department of revenue (for example, taxes)
PARIS Interstate file
PARIS Veterans file
Master Death Index
Public Death Records
Public Birth records

Eligibility factors that may be verified in government data sources include:
Federal Data Sources
SSA—Bendex: Provides SSA and SSI income information, SSN verification, and reports of deceased customers
PARIS Interstate File: Provides information on clients/households receiving benefits in another state
PARIS Veterans File: Provides information on veterans receiving benefits
State Data Sources
Unemployment Benefits: Provides State unemployment benefits information
Wage: Provides wage information from all State employers
Public Health: Provides birth and death records from State hospitals
Tax: Provides 12-month State tax information
New Hire: Provides information on new hires reported by all State employers

Eligibility factors that may be verified in commercial sources include:
Positive Identity: Verify attributes like SSN or address are legitimate and correctly associated with the member
State Residency: Validate member is a State resident, and monitor members for changes from in-state to out-of-state addresses
Income: Enhance member income eligibility profiles through access to paystub-level income information from sources like The Work Number
Assets: Provide real property, title registration, and neighborhood-level demand deposit accounts information for members to detect potential cases of fraud
Incarceration: Verify if member is currently incarcerated, and monitor members for changes in incarceration status
Death: Verify if member is deceased, and monitor members for appearance on the Death Master Index

Screens may be provided to display, and allow for the maintenance of, electronic data matching results from a state extract and from external data sources. These screens display the data matching results returned per specified Eligibility Factor and must allow for the evaluation of those factors. Eligibility factors supported by these screens may include:
Income (including Expenses)
Citizenship/Legal Residency
State Residency/Phone
SSN Validity
Other Insurance
Assets
Household Size
Income Leads

In addition to the screens for eligibility factors, screens are provided to display of current case members and the ability to add new members, as appropriate.

In some embodiments, the data broker system used to perform electronic data matching employs an open source technology, such as WS02 technology. The system may support major standard protocols via, in one case, Enterprise Service Bus (ESB). The system may support handling of batch files in different formats. Connectivity may be enabled for transports and protocols (HTTP, HTTPS, POP, IMAP, SMTP, JMS, AMQP, JSON, XML, SOAP 1.1, SOAP 1.2, or WS-*. In one embodiment, the system uses a NoSQL database that accommodates different data formats, including structured, semi-structured and unstructured. The system may include a middleware stack that is optimized for service-oriented architecture (SOA). In certain embodiments, the system is implemented on a multi-tenant cloud platform.

In some embodiments, data broker module 106 is implemented on a data broker sub-system. The data broker sub-system may be a stand-alone system. A data broker sub-system may provide data matching, data aggregation, and timeout handling by data source. The data broker subsystem may handle request/respond functions and portfolio monitoring with alert notifications. In one embodiment, the data broker sub-system supports periodic (e.g., monthly) check of a redetermination population with inquiry file generation. The data broker sub-system may also provide monitoring of a full client list against available data sources to detect pre-defined events (e.g. death match). The data broker sub-system may operate in batch, interactive, or combinations thereof. Batch file categories may include full files (entire population, complete set), incremental files, and inquiry based.

In the system illustrates in FIG. 1, data matching is performed in by a data broker module that accesses data via external systems. Electronic data matching may, nevertheless, be in various embodiments, performed on any other component or sub-system. In some embodiments, data matching used data from external sources, including data broker systems controlled by data broker operators whose systems are operated independent of the eligibility determination system. Electronic data matching may, nevertheless, be in some embodiments performed on a computer system integrated with the eligibility review module, using only data that is resident on that system (without, for example, reliance on information from outside data brokers).

Application tracking module 106 may provide document process management, missing information management, and document image management systems. Application tracking module 106 performs tasks to support eligibility verification, including document management, notifications, outreach, application processing, and imaging. The document processing flow allows for documents received after a determination of eligibility has been completed (Post Outcome Documents task). In some embodiments, application tracking module 106 enables automated generation of initial Renewal Form, subsequent case type-specific redetermination letters, information requests, continuation notices and authorized representative letters.

In some embodiments, a system performs computations and generates graphical or tabular information about operations or processes, such as system performance, task management, workflow management, or error detection. Information from computations performed by the system may be presented to users in the form of dashboards, reports, and alerts. In certain embodiments, the system performs computations to perform an optimization, a simulation, or both.

Eligibility verification system 101 may provide users with displays including dashboards, reports and analytics. Reports may be provided for assessing the effectiveness of the system in achieving program integrity, for example, error audit reports.

As illustrated in FIG. 1, eligibility verification system 102 may include, and/or may be implemented as, multiple functional modules or components, with each module or component including one or more provider network resources (e.g., computing resources, storage resources, database resources, etc.). Eligibility verification system 102 may include more or fewer components or modules, and a given module or component may be subdivided into two or more sub-modules or subcomponents. Also, two or more of the modules or components as shown can be combined.

In some embodiments, business units, user roles, task templates and virtual human task

(VHT) evaluation conditions necessary to support routing tasks to state staff workers in different units are defined based on the type of case (program type within the system) that the redetermination is being processed for. The system may be configured using code values that are specific to each project. For all code values corresponding to defined State values, the code values in question can be displayed on the system screens using the exact value of the code value concatenated with a description. This method of display allows users to enter in place the code value in order to be positioned on that value in the code table pick list.

Contact center 102 may be connected by way of a network to eligibility verification system 101. Contact center 102 provides clients with access to a call center for status and general inquiry relating to various benefit programs. Clients may communicate with agents 113 at contact center 101. Client access devices may include telephone, mobile phones, personal computer systems, or other electronic device. In some embodiments, client access devices communicate with agents at a contact center via multiple networks. For example, clients may variously make contact with the agents by way of the internet, publicly switched telephone network (“PSTN”), and wireless telephone networks.

Online portal 103 is provided for state workers to manage cases, collaborate, and access data match information. Information made available includes verified data on customer's income, resources, Illinois residency and, if previously unverified, citizenship or immigration status with a recommendation concerning eligibility. All verifications, images of documents and notices used by the system may be stored and made available for viewing by state staff. At a later date, document images may also be available in Content

Manager. Caseworkers may also view the recommendations in the Eligibility Verification System.

### Eligibility Verification Processes

The following are examples of eligibility verification processes that may be performed in an eligibility verification system such as the system described relative to FIG. 1. In each case, the eligibility verification system may provide verification without the state having to rely on self-reporting alone to identify changes.

### Passive Renewal

In some embodiments, an eligibility verification system is used in a passive renewal of a Medicaid benefit. If State is able to renew coverage based on information in account and databases, the State sends renewal notice explaining eligibility determination and basis. The enrollee may be required to update only if any information is incorrect. If the enrollee does not respond after 30 days, state renews coverage. If the enrollee sends updated information, state verifies and redetermines eligibility.

If the State is unable to renew coverage, either due to insufficient or conflicting information, or determination of ineligibility, the system pre-populated a form containing information known to state and sends the client a request for additional information. If the enrollee responds with 30 days, the state verifies and redetermines eligibility. If not, state may check for eligibility for QHP/APTC before terminating coverage.

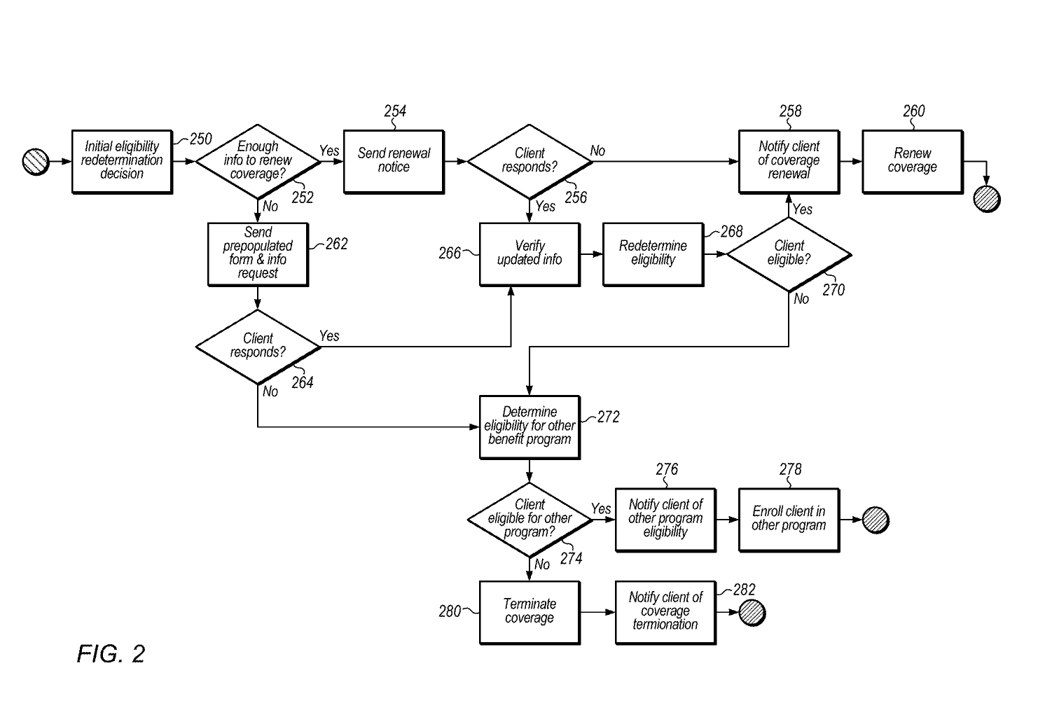

FIG. 2 illustrates one embodiment of a passive renewal process that includes electronic data matching. At 122, a process is initiated to make an initial redetermination decision. At 252, the case is evaluated to determine whether there is enough information to renew coverage. If there is enough information, a renewal notice is sent at 254. If there is not enough information, a form is prepopulated and an information request is sent to the client at 262.

If a renewal notice is sent, the system looks for a response and determines whether a client has responded at 256. If the client does not respond, the client is notified of coverage renewal at 258 and coverage is renewed at 260. If the client responds at 256, any updated information is verified at 266 and a redetermination is performed at 268. If the client is eligible, the client is notified of coverage renewal at 258 and coverage is renewed at 260.

If an information request is sent at 262, the system looks for a response and determines whether a client has responded at 264. If the client responds, any updated information is verified at 266 and a redetermination is performed at 268. If the client does not respond, the system determines if the client is eligible for another program at 272.

At 274, if the client is eligible for another program, the client is notified of the other program eligibility at 276 and may be enrolled in the other program at 278. If the client is not eligible for another program, coverage is terminated at 280 and the client is notified of the termination at 282.

### Ongoing Eligibility Verification

In some embodiments, an eligibility verification system is used to perform ongoing eligibility verification for a benefit. Initially, the State determines eligibility and enrolls the clients into a program. Thereafter, the system performs ongoing program integrity to ensure that consumers are appropriately placed in correct programs. Program participants may be reassigned to correct programs based on the most current eligibility information. In response to the determination, consumers may be placed in one of the following:
1. Consumers remain in assigned program
2. Consumers are redirected to FFM for APTC/Tax Credit eligibility
3. Consumers are dis-enrolled from program (found to be collecting out of state benefits or have passed away)

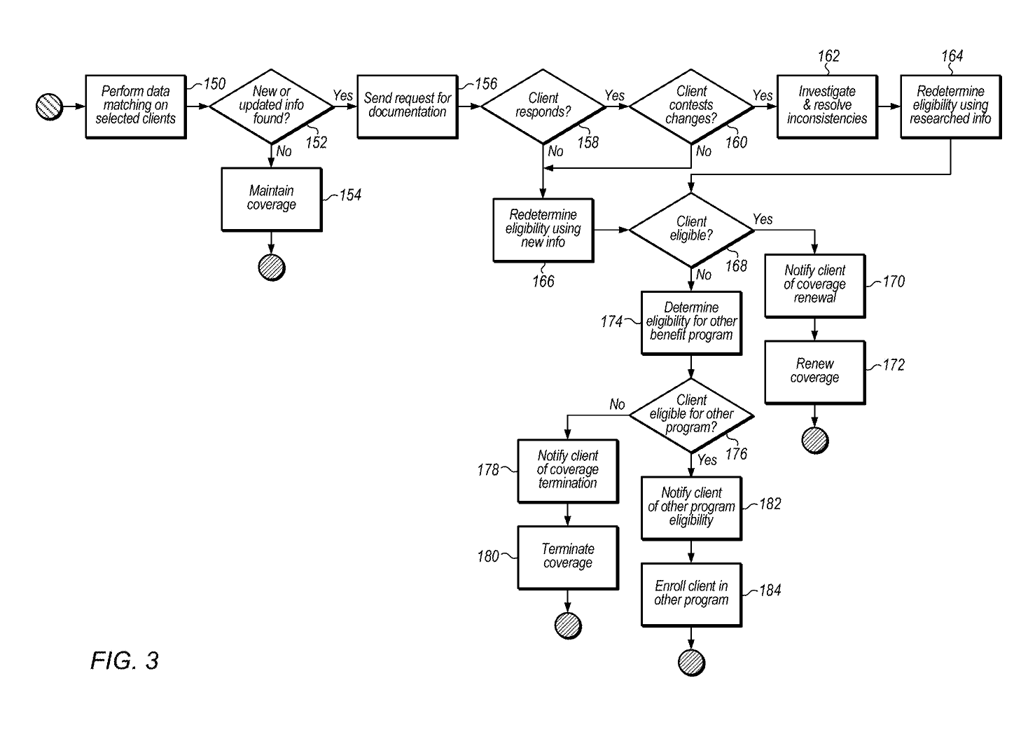

FIG. 3 illustrates one embodiment of performing an eligibility determination on selected clients between passive annual redeterminations. At 150, data matching is performed on selected clients. At 152, if no new or updated information is found, coverage is maintained at 154. If new or updated information is found, a request is sent for documentation at 156. At 158, the system determines whether the client responds. If the client contests the changes, inconsistencies are investigated and resolved at 162 and eligibility is re-determined based on the researched information at 164. If the client does not contest the changes at 160, the system redetermines whether the client is eligible using the new information at 166.

At 176, if the client is eligible for the program, the client is notified of coverage renewal at 170 and coverage is renewed at 172. If the client is not eligible for the program, the system determines if the client is eligible for another program at 174. At 176, if the client is eligible for another program, the client is notified of the other program eligibility at 182 and may be enrolled in the other program at 184. If the client is not eligible for another program, the client is notified of the termination at 178 and coverage is terminated at 180.

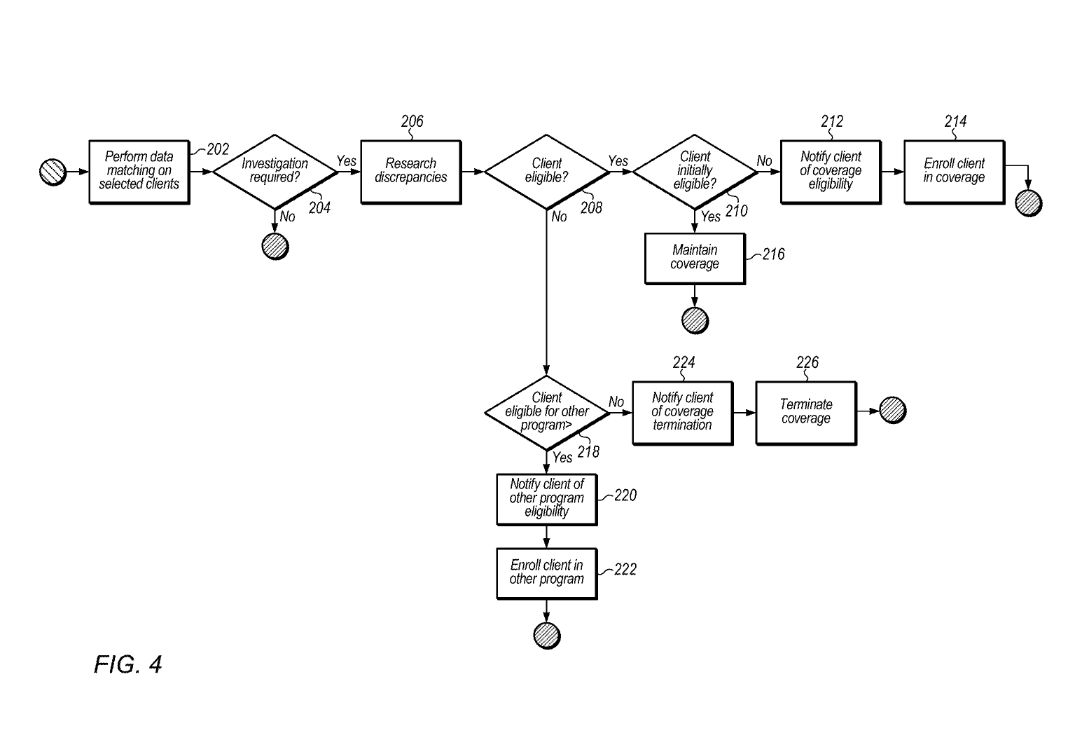

In some embodiments, results of eligibility verifications by a system using electronic data matching are used to assess and ensure program integrity. FIG. 4 illustrates one embodiment of performing electronic data matching on selected clients for program integrity verification. At 202, data matching is performed on selected clients. At 204, an assessment is made of whether an investigation is required. If an investigation is required, discrepancies are researched at 206. At 208, if the At 210, if the client is initially eligible, coverage is maintained at 216. If the client is not initially eligible, the client may be notified at 212. If appropriate, the client may be enrolled at 214.

If the client is not eligible at 208, the system may determine whether the client is eligible for another program at 218. If the client is eligible for another program, the client is notified of program eligibility at 220 and the client may be enrolled at 222. If the client is not eligible for another program, the client is notified of the termination at 224 and coverage is terminated at 226.

### Post-Eligibility Review

In some embodiments, an eligibility verification system is used to perform a post-eligibility review of eligibility for a benefit. Initially, the State determines eligibility and enrolls clients into a program. After the initial determination, an eligibility review may be performed a predetermined interval. The eligibility review may include assessing cases the purposes of error or fraud. Participant eligibility may be verified through third party data sources. Participants found to be incorrectly determined for Medicaid eligibility but eligible for another program are reassigned to that program. Participants found to be receiving benefits in another state or who are found to be deceased are flagged as potentially fraudulent enrollees. In certain embodiments, new PARIS or death master index files are compared to the state records of active enrollees to identify those who are clearly ineligible.

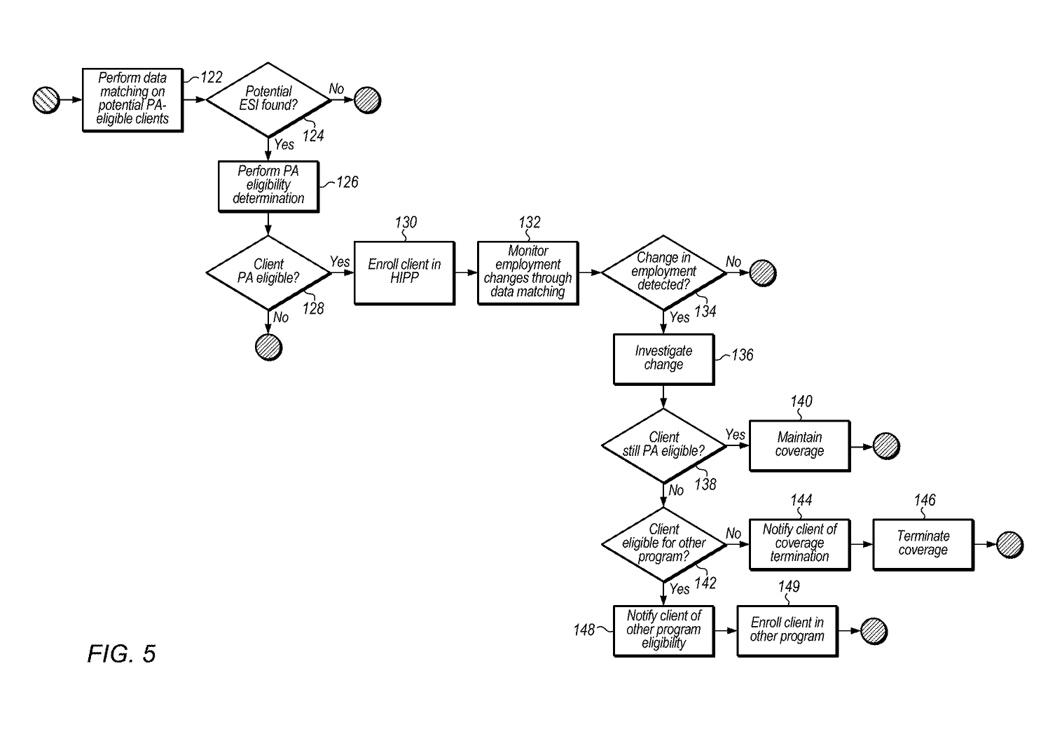

In some embodiments, eligibility verifications using electronic data matching are used in a premium assistance program. FIG. 5 illustrates one embodiment of performing electronic data matching in a premium assistance program. At 122, data matching is performed on potential premium-assistance eligible clients. If a potential ESI is found at 124, a premium assistance eligibility determination is performed at 128. If the client is eligible, the client is enrolled at 130.

At 132, data matching is used to monitor employment changes. If a change of employed is detected at 134, the changed is investigated at 136. If the client is still eligible, coverage is maintained at 140. If the client is not eligible premium assistance eligible at 138, the system may determine whether the client is eligible for another program at 142. If the client is eligible for another program, the client is notified of program eligibility at 148 and the client may be enrolled at 149. If the client is not eligible for another program, the client is notified of the termination at 144 and coverage is terminated at 146.

In some embodiments, the system makes recommendations concerning continued eligibility based on electronic verifications and any information provided by the customer. In one embodiment, one of the following recommendations is made:
Case Likely to be Ineligible—when electronic information identifies the client is deceased, the household has moved out of state, or countable income exceeds income standards;
Case Likely to be Eligible—when electronic information verifies current ongoing income eligibility and all factors of eligibility appear to be met;
Cases Likely to Require a Change—when electronic information identifies a change needed to the number of members in the household due to a death of one member, one member moves out of state, or identified income would change the type of program the household should receive;
Insufficient Information to Make a Recommendation—when electronic information available about the household does not clearly identify ongoing eligibility, ineligibility or a necessary change.

In medical-only cases, recommendations may include one of the following:
Continue Benefits
When available information supports continuation of medical coverage for the same program, it is recommended that case remain eligible for the current medical program.
Cancel Benefits
When the electronic information supports cancellation (for example, verified income is higher than the program standard), a Notice of Prospective Ineligibility is mailed to the customer requesting an explanation or different information. The customer has 10 business days to contact provide requested information. If the customer fails to respond within 10 business days, a recommendation is made to canceling the case with the appropriate reason.
Change Benefits
When the information supports the case being eligible for a different program or someone in the case is no longer eligible, a program change is recommended.

### Process Flow in an Eligibility Verification System

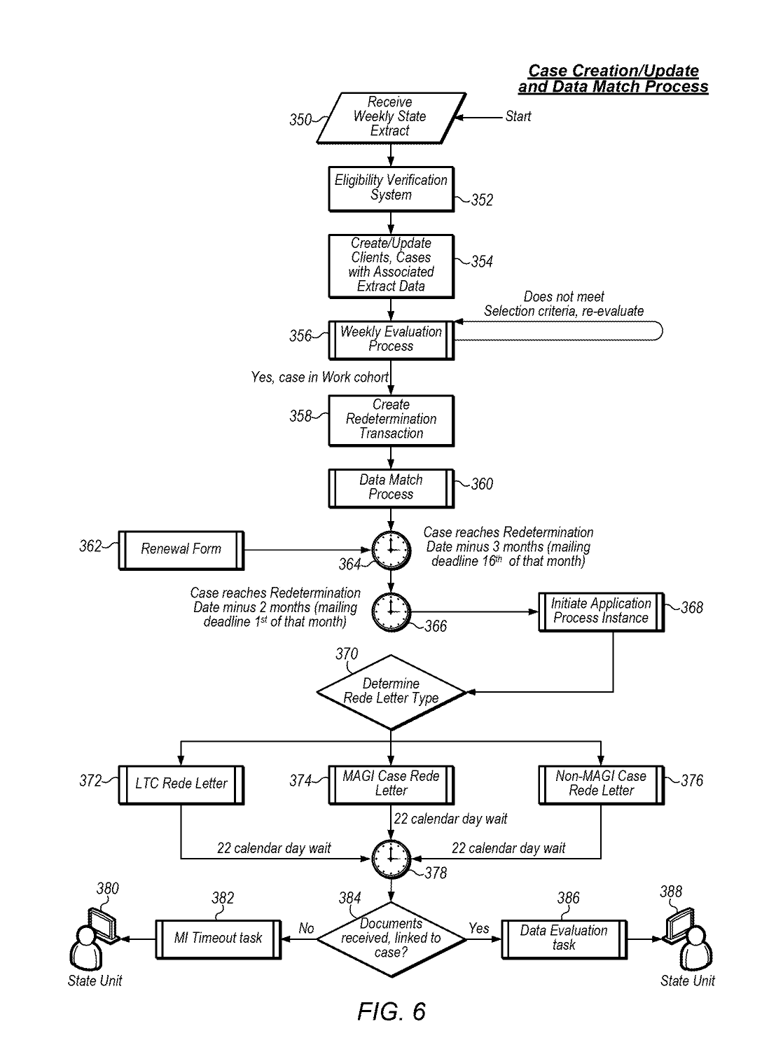

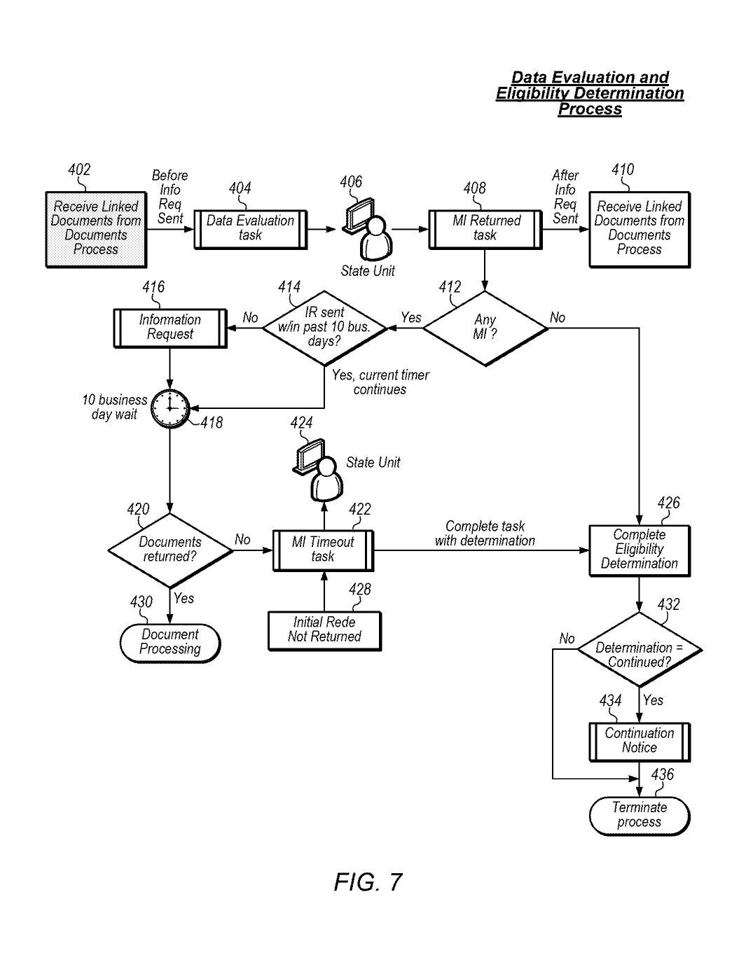

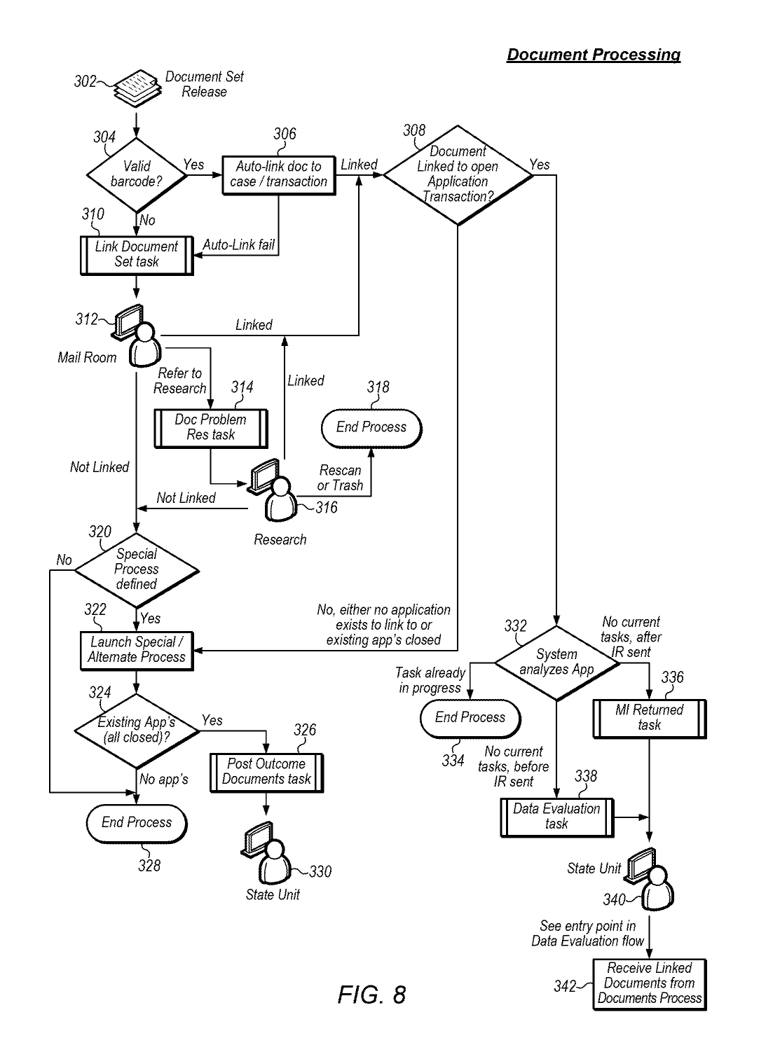

FIGS. 6 through 8 outline the processing flow in one embodiment of using an eligibility verification system to manage documents, case creation/data matching and data evaluation/eligibility determination. FIG. 6 illustrates case creation/update and data match process in one embodiment of an eligibility verification system. FIG. 7 illustrates data evaluation and eligibility determination in one embodiment of an eligibility verification system. FIG. 8 illustrates document processing in one embodiment of an eligibility verification system.

In some embodiments, an eligibility verification process begins with the receipt and processing of an extract from records for a governmental entity, such as a state. A State extract may be periodically generated from one or more databases for a specific State. The State extract may be made, for example, on a weekly basis. Thus, in FIG. 6, a weekly state extract is received at 350. The data in the State extract may be received in the eligibility verification system at 352. From the State extract, the system may automatically create cases and associated recipients at 354. The eligibility factors information included on the extract may be associated with those recipients and cases. At 356, the caseload may then be evaluated to determine the cohort of cases that are required to be worked based on their upcoming Redetermination Date and other criteria as appropriate.

In some cases, the primary criterion for selection of a case is reaching the threshold of the case's Redetermination Date minus X calendar days. X is configurable, and for day one processing, will be set to 89. In addition to the standard cases selected based on proximity to their Redetermination Date, there may be an exception population of cases that must enter the work cohort based on a defined set of conditions not tied to Redetermination Date. As one example, the conditions may include:
Medicaid recipient turning 65 during month prior to the target month
Medicaid recipient turning 19 during month prior to the target month
Foster Care recipient turning 26 during month prior to the target month
Youngest recipient on Medicaid case turning 18 during month prior to the target month
Medicaid recipient starts receiving Medicare during the target date range

In one implementation, a value of a TRIGGER REASON CD field in a table is displayed on a summary screen. In addition, the attributes for the table will be added to the Task payload. This will enable the Task List screen to be configured to display TRIGGER_REASON_CD as one of the columns on the Task List.

### Redetermination Transaction

When a case is selected for the Work cohort, the system may create a Redetermination transaction at 358 (which may also be referred to herein as an Application) that follows the steps in the eligibility verification process flow from initial evaluation of the data returned from the Data Match process at 360 to a final determination of eligibility. The Redetermination transaction may serve as the focal point for recording all activity that transpires in the processing of the case in question. Application Log events may record the tasks that are created, claimed and completed in the course of determining the case recipients' eligibility for services.

When a case does not yet meet the criteria for being worked, the case is re-evaluated on a weekly basis (with the ability to adjust the frequency of that evaluation as needed). This process continues until the case either closes or is selected for work in that month's work cohort.

### Data Match and Renewal Form

Data match interface requirements may be established for the data sources. Once a Redetermination transaction is created, the system initiates a data match request to the Data Match vendor to search through mandatory data sources for information related to the recipients' eligibility factors. The data match results may include multiple addresses for the head of household. When the case reaches the threshold of Redetermination Date minus 3 months (364), the system generates a Renewal Form at 362 and mails it no later than the 16th of that calculated month (i.e., Feb. 16, 2015 for cases with a May 1, 2015 Redetermination Date). The form is sent to the address of record from the State extract and to any unique addresses obtained through the data matching results. If two addresses share the same house number and ZIP code, they are considered duplicates. The system sends the Renewal Form to each address that is determined to be unique based on the above comparison.

### Application Process and Case Type-Specific Redetermination Letters

When the case reaches the threshold of Redetermination Date minus a pre-determined period (e.g., 2 months) (366), the system initiates an instance of the Application process at 368 to initiate workflow and track activity that transpires in the processing of the Redetermination. At 370, the system analyzes the case type to determine whether the case recipients should receive an LTC Redetermination Letter (372), a MAGI Case letter (374) or a Non-MAGI case letter (376). At 378, the system also initiates a process timer to define the interval of time that the recipient has to return the Redetermination Letter and/or required documentation before they are considered non-compliant. The timeout interval for all 3 Redetermination Letters may be, for example, 22 calendar days.

### Data Evaluation and Missing Information Timeout Tasks

At 384, if documents are received during the wait interval and linked to the case/recipient, then the system generates a Data Evaluation task at 386 to the appropriate State business unit 388. Details regarding the triggers for generating a task, and requirements for routing a task may be maintained in an Eligibility Verification Task Inventory, such as further described herein.

If the wait interval elapses with no documents being received and linked to the case/recipient, then the system creates a Missing Information Timeout task at 382 to prompt worker evaluation of the Redetermination at 380 and likely entry of Cancelled as the eligibility determination due to non-compliance.

When a Data Evaluation task is completed by the State user, the system evaluates whether there has been a finding of Missing Information (MI) and/or a determination of eligibility.

### Missing Information Cycle, Information Request and Missing Information Returned Task

When a Data Evaluation task is marked as completed (Complete button clicked), if missing information has been defined and no eligibility determination has been made, then the system automatically displays a screen allowing the user to enter a free form text field to specify required documentation to a greater level of detail than is supported by the designation of higher level eligibility factors as Missing. When the user selects the Save button from this screen, the system generates the Information Request letter request and completes the Data Evaluation task. When the user selects the Cancel button, the system returns the user to the Application Tracking Status screen and the Data Evaluation task is not completed. The user has the ability to modify the Eligibility Factor evaluations and recycle through the Information Request logic listed above or they can enter an eligibility determination and complete the Data Evaluation task.

If no Missing Information has been defined and an eligibility determination has been made, the system terminates the Application process and the Redetermination is considered complete.

If no Missing Information has been defined and no eligibility determination has been made, then the system displays an error message since the user must either designate at least 1 eligibility factor as Missing or must enter an eligibility determination in order to proceed.

When an Information Request is sent, the system initiates a 10 business day timer at 418. If documents are returned and linked to the case/recipient within that 10 business day interval, the system determines whether a Missing Information Returned task should be generated to prompt the user to evaluate the additional information on those documents.

The process will not create subsequent Information Requests during the 10 business day interval that kicks off from creation of the initial Information Request.

For example, the Information Request is generated on Mar. 12, 2015 based on completion of a Data Evaluation task with Missing Information and no prior information request sent within the past 10 business days. The system initiates a 10 business day timer for all requested documents to be returned. In some embodiments, requested documents on the information request are citizenship verification and income verification. Recipient sends in 4 paystubs on March 19 (business day 3). Documents are linked to the case/recipient and the application in progress. The system notes that documents have been received after an information request had been generated for the application, so system creates a Missing Information Returned task. A user claims task, looks at paystubs and updates evaluation for that recipient's Income eligibility factor from Missing to Accepted. However, Citizenship/Legal Residency factor remains evaluated as Missing because citizenship proof has not been submitted. Because Missing Information Returned task was completed with

Missing Information and no eligibility determination, 10 business day timer continues to run.

On March 25 (business day 7), recipient sends in copy of birth certificate. Again, upon linking of document to case/recipient and application, system creates another Missing Information

Returned task. Because most recent information request was generated within past 10 business days, system does not create another information request. State user claims task, updates that recipient's Citizenship/Legal Residency eligibility factor from Missing to Accepted and enters an eligibility determination. Based on completion of the Missing Information Returned task with no Missing Information and an eligibility determination, the system terminates the Application process and the Redetermination is considered complete. If the user attempts to complete the Missing Information Returned task with no Missing Information and no eligibility determination, the system displays an error message since the user must either designate Missing Information or enter an eligibility determination.

If no additional documents were received after the paystubs during the 10 business day interval, the system would have created a Missing Information Timeout task instead.

In the example shown in FIG. 7, linked documents are received from a documents process at 402. A data evaluation task 404 is initiated assigned to the State user at 406. A Missing Information Returned task may be undertaken at 408. If there is missing information, if an information request has been sent within the past 10 business day, the current timer continues. If not, an information request may be sent at 416 and a new timer initiated at 418. At 420, if the documents are returned, document processing is carried out at 430. If the documents are not returned, an MI timeout task is carried out at 422. At 426, an eligibility determination is completed.

### Continuation Notice

Upon completion of the Redetermination, when the eligibility determination has been set to Continued at 432, the system will automatically generate a Continuation Notice for the case 434. At 436, the process may be terminated.

### Document Processing

The document processor module may implement a Document Processing path that is followed for documents received and linked to a case/recipient after the Redetermination transaction for that case has been completed with an eligibility determination. The Document process defines how documents are managed from the point that the document metadata is released to the system from the Imaging solution. The process creates a Post Outcome Documents task to the appropriate State business unit. Front-end scanning, classification, data entry and image processing (including pushing images to a State content manager) may be performed prior to an instance of the Document process being initiated.

FIG. 8 illustrates one embodiment of document processing. At 302, a document set is released. At 304, if there is not a valid bar code, the Link Document Set task is undertaken at 310. At Mail Room 312, the document may be handled through Research as illustrated in 314-318 and/or special processing as illustrated in 320-330.

At 304, if there is a valid barcode, an auto-link to case/transaction is attempted at 306. At 308, if the document is linked to an open application transaction, the system analyzes the app at 332. If a task is already in progress, the process is ended at 334. If there are no current tasks, after the information request is sent, the MI Returned task may be undertaken. In other cases, a data evaluation task 338 may be undertaken. At 342, linked documents are received from the Documents process.

In some embodiments, tasks are routed based on the case type of the associated case. In certain embodiments, the workflow implements Virtual Human Tasks (VHT). Generic tasks may be generated at specified points within the workflow. These generic tasks may provide the overall blueprint for defining where in the process flow the generic task should be triggered.

To support customization, such as routing tasks to different business units based on case type, the workflow provides for the ability to create different VHT's presented to the user based on the common trigger point defined by the generic task in question. The workflow decides which VHT to generate by interrogating evaluation expressions that operate on data contained within the task payload. If an evaluation condition is met, then the workflow generates the VHT associated with that condition.

For example, the process flows above define the trigger point for the generic Data Evaluation task to be the receipt of documents and linking of those documents to the case/recipient and open Redetermination prior to an Information Request being sent out on the case. At the point that this condition is recognized within the workflow, the system correctly identifies the need to generate a generic Data Evaluation task. It then checks for the presence of any VHT evaluation expressions associated with the generic Data Evaluation task and finds a series of expressions based on evaluating case type. It starts with the first expression and evaluates each expression in sequence until an expression is met. At the point that an expression is met, it determines the VHT associated with that expression and generates that specific VHT instead.

In this example, the first expression evaluated as met states that if the case type for the case=Medical Extension, then generate the Medical Extension Data Evaluation VHT. The task template for this VHT defines the FCRC Transaction Support—Medical Extension Unit as the default business unit to receive this VHT version of the generic Data Evaluation task. For each project, tasks, both generic and VHT, that are to be generated within the system may be defined. Each task may include the following attributes:
Task Template Name (Generic vs. VHT): The actual name of the task template, and whether the template defines a generic task or a VHT
Display Name and Description: The task name value displayed to users. In some cases, the task template name reflects generic baseline terminology, such as State Data Entry. However, the task name actually displayed for that same generic task will be set to Data Evaluation to be specific to the required terminology for the project.
Default Business Unit/VHT Evaluation Expression: The default business unit designated to receive the task and the default priority and time to complete the task. (For example, priority may be set to a default value of 3 and time to complete may be set to a default value of 3 business days.) For a VHT, the column also defines the evaluation expression that must be met in order for the VHT to be generated.
Task Trigger and Target Screen: The trigger point within the process for generating the generic tasks that are listed. Each VHT associated with generic tasks shares that same trigger point with the additional condition that the VHT evaluation expression must be met when that trigger point is reached. The target screen that the user is taken to when they claim or work the task in question may also be defined.
User Actions: The actions that a user is allowed to take from the target screen in regards to the task in question.
Actions and Resulting Updates: The updates performed by the system when a specific user action is taken on the task in question. This includes instances where the action completes the current step in the process and initiates a subsequent step. For example, where a Data Evaluation task completed with missing information and no eligibility determination, the system may be prompted to generate the

Information Request letter and initiate a wait step (for example, 10 business days) within the process.

### Eligibility Verification Letter Generation

The following are examples of letters that may be generated from within an eligibility verification system in various embodiments.
1. Renewal Form: General letter to inform the recipient that it is almost time for their renewal and they should expect to receive their Redetermination Letter within 20 days.
   a. Triggered by calculation of mailing deadline for form (Redetermination Date minus 3 months, form must be mailed no later than the 16^{th} of that calculated month. Therefore, letter request must be generated within the system at least 2 business days prior to the 16^{th} of that calculated month.)
2. LTC Redetermination Letter: Redetermination letter specifically tailored for Long Term Care recipients informing them of their obligation to fully fill out and sign the associated forms and return them prior to the letter due date. That date is defined as the sent date of the LTC Redetermination Letter request+22 calendar days.
   a. Triggered by calculation of mailing deadline for the letter based on case type:
      i. Nursing Home/SLF,
   b. Redetermination Date minus 2 months, form must be mailed no later than the first of that calculated month. Therefore, letter request must be generated within the system at least 2 business days prior to the first of that calculated month.
3. MAGI Case Redetermination Letter: Redetermination letter specifically tailored for MAGI Case recipients informing them of their obligation to fully fill out and sign the associated forms and return them prior to the letter due date. That date is defined as the sent date of the MAGI Case Redetermination Letter request+14 calendar days.
   a. Triggered by calculation of mailing deadline for the letter based on case type.
   b. Redetermination Date minus 2 months, form must be mailed no later than the first of that calculated month. Therefore, letter request must be generated within the system at least 2 business days prior to the first of that calculated month.
4. Non-MAGI Case Redetermination Letter: Redetermination letter specifically tailored for Non-MAGI Case recipients informing them of their obligation to fully fill out and sign the associated forms and return them prior to the letter due date. That date is defined as the sent date of the Non-MAGI Case Redetermination Letter request+14 calendar days.
   a. Triggered by calculation of mailing deadline for the letter based on case type.
   b. Redetermination Date minus 2 months, form must be mailed no later than the first of that calculated month. Therefore, letter request must be generated within the system at least 2 business days prior to the first of that calculated month.
5. Information Request: Letter sent to recipients informing them of required information that is missing for their redetermination. Recipient must provide all the required information from that form by the letter due date or they will be considered non-compliant. The letter due date for the Information Request is defined as the sent date of the letter request+10 business days.
   a. Triggered by completion of a Data Evaluation task with at least one eligibility factor set to an evaluation value of Missing and no eligibility determination having been entered.
6. Continuation Notice: Notice sent to the recipient when their redetermination is completed with an eligibility determination of Continued informing them that they will continue in the designated program, they should expect to receive a new card shortly and they are required to report certain changes in circumstances to the state human services department within 10 days.
   a. Triggered by completion of a redetermination with an eligibility determination of Continued.
7. Authorization Request Form: Form that is sent to the head of household when State needs to confirm that the recipient has an officially designated authorized representative.
   a. Triggered by user selection of the Authorization Request forms request from the Forms Request menu once they are positioned on the case in question. The form request will be configured as a case-driven forms request
      Recommendations based on Income Limits

In some embodiments, income information reported by the different data sources is used by the system to provide an electronic recommendation on cases that are in process. This recommendation may, in some cases, be only a recommendation based on simplified assumptions and calculations and not a determination. In this case, the information may be used to prompt a worker to do income based calculations and make a determination. In some embodiments, Income and Asset information is aggregated for display on both the MAGI and the Non-MAGI Case Redetermination Letters

### Income Data Sources & Filters

In some embodiments, filters/rules are applied to the different data sources to determine the records to use as a source of income and how to calculate total monthly income for each data source and each active member on the case. The following describe rules that may be used in one embodiment.

TWN (The Work Number) Wage information

This is usually a monthly (on-demand) file that provides wage information reported from employers.

Rules:
Consider matched records only (matched_active_record=‘Y’)
Use information from the current pay period record. If this record is empty (i.e. no pay period, pay date, or gross earning), then consider the last record from the previous pay records if not empty (make sure to use the relevant fields from the previous pay period section).
Only select record if:
   Pay date (cpp_pay date) is within the last 60 days.
   Employment is not terminated (check for empty employee_termination_date)
Use the gross pay amount reported (cpp_gross_earnings).
Determine the pay period (i.e. weekly, bi-weekly, monthly, etc) based on the difference between pay begin date (cpp_begin_date) and pay end date(cpp_end_date). Based on this determine the frequency factor to apply to the gross amount to come up with the monthly gross amount.
Add the monthly income from all the employers reported for the matching client.

### State Quarterly/Monthly Wage Information

These are sets of files that come in monthly (usually) that report monthly/quarterly wage information from all employers in at state.

Rules:
Use the most recent Monthly/Quarterly record. That is, use the last monthly unless the last one is a quarterly submission and in this case, use the quarterly and divide amount by 3. Note that if the client is/was employed by more than one employer multiple records could be reported in the file. So for each client, the system will select the last monthly/quarterly record reported for each employer. Add the monthly income from all the employers reported for the matching client.
Only include records with effective dates within the last 90 days.

### Unemployment Benefits

This is a weekly file that provides information on unemployment benefits received by a client from a state unemployment agency. Rules:
The received records reflect weekly frequency.
Select the last record within the last 30 days. Use the pay date as a reference. Select one record only. Note that the unemployment file usually includes 2 separate records for an individual where each record corresponds to a one week period and reflects a weekly amount. We can therefore either add these 2 records and then multiply by 2.15 or use the last record and multiple by 4.3. For simplicity sake, use the last record and multiply by 4.3.
Multiply the amount by 4.3 to come up with the estimated monthly amount.

### SSA-BENDEX

This is a monthly file that provides information on social security benefits. Rules:
Select records that have a payment status that starts with “C” (for current) in field “FED-14-PYMT-STATUS” with a monthly benefit amount “FED-15-MON-BEN-AMT” over zero. This monthly benefit field is different from the SSI amount field, so SSI income is not selected.
Select records from the last BENDEX file that was received, however, the file must be within the last 60 days.
Multiple records could exist for the same individual, so add them together if they match the above conditions.

### Income Hierarchy

In one embodiment, the system uses the rules set forth below to determine which of the data sources reported income to add together to calculate the estimated monthly income for an individual.
Add reported wage income from TWN.
If reports no income or no match, then add State Monthly/Quarterly reported income.
Add Unemployment Insurance reported income.
Add BENDEX reported income.

Income standards may be based on the Federal Poverty Level published each fiscal year.

In some embodiments, some programs are excluded from consideration, such as following programs and as a result cases in these programs will default to an E-Recommendation based on income of “likely eligible”.

### Income Recommendation Rules

The income based Recommendation may be based on a set of simplified rules/calculations that will be used by the system to indicate the likelihood or the unlikelihood of eligibility. No handling for exceptions, exclusions or special provisions. State Caseworkers may be responsible for reviewing the case, making the necessary calculations and entering the appropriate determination.

In one embodiment, an income based recommendation is based on the following 3 factors: Household size, Program type, and total estimated monthly income for all the active members.

Household size: To determine the household size applicable for this calculation, the system will use the following logic:

Program Type: This is the calculated program type of the case (i.e. one of the 9 programs identified though the program mapping logic used in the system).

Total Income: Total all the income from all the active members in the case. Active members are the individuals marked as active beneficiaries on the case. Included income is based on the rules listed earlier in this document.

Income based Recommendation

The total monthly income, household size, and program type may be compared against the income standards table for the corresponding program.
If the total income is:
Over limit: recommend=>likely ineligible
Under or equal limit: recommend=>likely eligible

If the case program type is one of the programs with no income standards defined, then assume income-based recommendation is “likely eligible”. The income based Recommendation may have a lower priority that other factors that contribute to the recommendation, such as residency or death.

Recommendations based on Death Records

In some embodiments, death records from the different data sources are used by the system to provide an electronic recommendation on cases that are in process. The following describe the data and rules that may be used in one embodiment.

Client List: The full client list is based on:
Client information received in the State extract file.
The client is active in at least one case where the case falls into one of the program types that are supported by the system.

Data Sources: A check may be performed against the following data sources:
Master Death Index files
Public health death records
BENDEX (if field FEDSX-DEATH-JUL-DTE has non-zero data)
PARIS VA (if the value ‘DB’ is contained in any of the change reason fields)

In some embodiments, a match is based on the client's SSN. Upon occurrence of a match, an alert may be generated against the client record. (The alert may be generated only once for any specific client.) The check may be done periodically (e.g., monthly).

When there is a match, the system may create a task for the case worker. When this task is worked, the user may be shown a screen with the client information, the alert information including the data source reporting the death information, and the list of associated cases and applications in the system where this client is active. The only action available to the user is to complete the task. If there are in-process applications, the user may click on the application link to be taken to the application summary screen. The user can then select the Tasks Tab under the application to see if there is an unclaimed task that can be worked.

### Account Transfer Object Intercept

Account Transfer Object (ATO) Intercept for Ensuring Proper Action based on Verified Eligibility.

An intercept process is applied to account transfer objects to ensure that a provider of a government benefit (e.g., a state Medicaid program) provides benefits consistent with information available from private and public data sources. The system performs data matching using multiple data sources to monitor and assess eligibility. The system may validate schema and, business logic, and data completeness, and identify actual or potential errors. Schema and logic errors addressed may include: duplicate applications; failed to transmit outbound referrals; multiple heads of household or missing tax relationships; missing identity verification; or erroneous family relationships invalid person names and addresses. Business and applications errors addressed may include:

Out of date income amounts; incarceration status missing or invalid; death status missing or invalid; incomplete employment data or income mismatch; or ambiguous address information. The system may perform outreach to participants to resolve incomplete information or inconsistencies. Once errors have been resolved, the provider (e.g., state) receives a complete and actionable account transfer object.

In one embodiment, an external sends account transfer objects to a State system as a referral for further processing by Medicaid/CHIP. The external system may be, for example, a federally facilitated marketplace (FMM) system. The account transfer object (ATO) Intercept may be applied to each of the account transfer objects being sent to the state system. The ATO intercept may be implemented by an eligibility verification system and/or data broker system.

The ATO Intercept may perform some or all of the following operations: validation for ATO structural integrity (for example, according to NIEM standards), enforce validation of business logic (for example, according to the CMS specifications), and enable data enrichment for completeness. The ATO intercept may verify that application data is complete and accurate for eligibility processing. The ATO intercept may also ensure that the object is structurally sound and actionable by the state and that field level logic is correct and void of potential errors.

Schema and logic errors that may be identified and/or resolve in the ATO intercept include:
Receiving duplicate applications
Failed to transmit outbound referrals
Programmatic exceptions during processing—NULL Pointer Error
Communication errors in transmission—SOAP Fault
Multiple heads of household or missing tax relationships
Invalid SSN and missing identify verification
Erroneous family relationships
Invalid person names and addresses
Invalid referral quantities in number of persons on the application

Business and application errors that may be identified and/or resolved in the the ATO intercept include:
Out of date income amounts
Incarceration status missing or invalid
Identity and Citizenship missing or invalid
Death status missing or invalid
Incomplete employment data or income mismatch
Ambiguous address information
Missing or invalid household relationships

Following application of the ATO Intercept, the state receives a complete and actionable ATO.

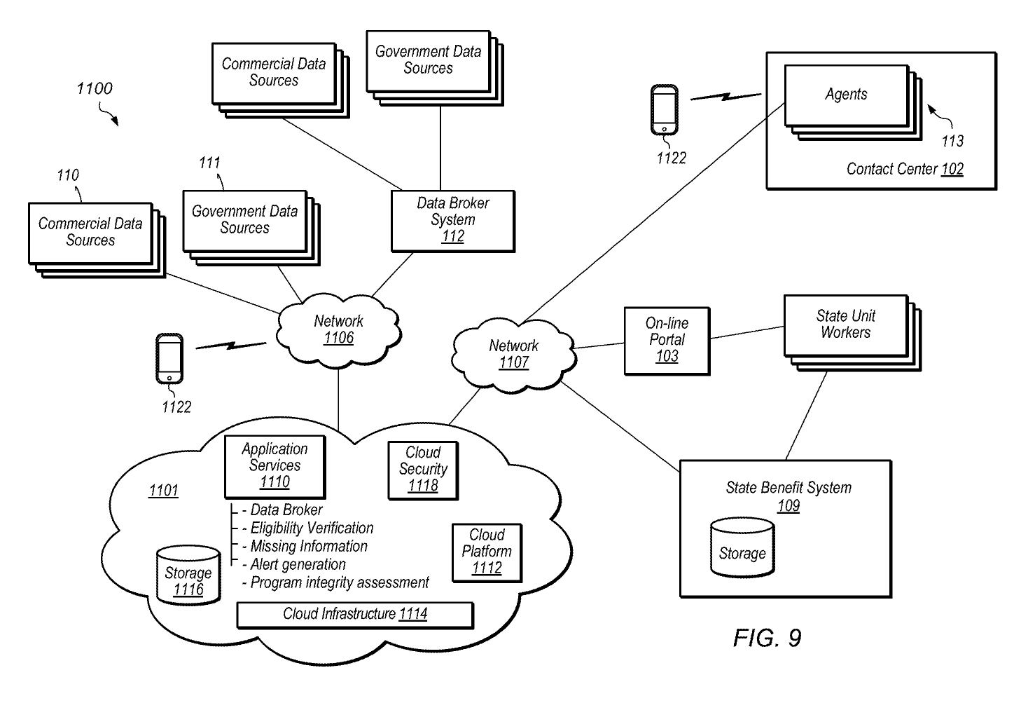

In some embodiments, services for eligibility verification and program integrity assurance are provided by way of a cloud computing system over a communications network. FIG. 9 illustrates one embodiment of a cloud computing system that can be implemented to provide eligibility verification services, missing information management, and program integrity assessment. System 1100 includes cloud computing system 1101 and contact center 102, and on-line portal 103. Client access devices 1122 may be telecommunications devices (for example, mobile phones or land lines) or computing systems (for example, personal computers) connected to network 1106. State benefit system 10, user access devices 1122, agent devices 113, on-line portal 103, and data broker system 112 may be connected to cloud computing system 1101 by way of network 1106 or network 1107.

Cloud computing system 1101 may provide remote computing resources, remote storage resources, or both, for systems connected to cloud computing systems 1101. For example, cloud computing system 1101 may provide cloud computing services to state unit workers or eligibility verification service providers by way of user devices on network 1106 and 1107.

Various system architectures may be employed in cloud computing system 1101. Systems and components of cloud computing system 1101 may be at a single physical location, such as a data center, or distributed among any number of locations. Cloud computing system 1101 includes cloud application services 1110, cloud platform 1112, cloud infrastructure 1114, cloud data storage 1116, and cloud security 1118. Cloud applications services may be implemented by way of one or more computer systems, each include one or more central processing units, such as described herein. Examples of application services 1110 include providing eligibility verification, error assessment, program integrity assessment, electronic data matching, missing information resolution, outreach, and reporting. Cloud application services 1110 may access cloud data storage 1116.

In some embodiments decision support services are provided to users using application services in a computing cloud. In one embodiment, product search, business intelligence, or combinations thereof, are performed as one of application services 1110. In certain embodiments, services in a cloud receive a message feed from a local computing system, such as one or more of data source computing systems, or from third party information providers.

Cloud infrastructure 1114 may encompass a variety of physical resources, such as computing devices, servers, block storage, mass storage devices, file servers, software, and network systems. In some embodiments, a cloud computing system encompasses virtualized resources, such as virtualized data storage or virtualized hardware.

In some embodiments, a service provider provides services to decision makers by way of cloud computing resources. In some embodiments, computation resources are rented or leased to customers of the service provider. In certain embodiments, services are provided to users at sites as software as a service (“SaaS”) or platform as a service (“Paas”). Services may be provided to each user on an on-demand basis.

Networks 1106 and 1107 may include any suitable data network or combination of networks that enable the exchange of information between electronic systems. For example, networks 1106 may include one or more Local Area Networks (LANs) such as Ethernet networks, as well as Wide Area Networks (WANs), Metropolitan Area Networks

(MANs), or other data or telecommunication networks implemented over any suitable medium, such as electrical or optical cable, or via any suitable wireless standard such as IEEE 802.11 (“Wi-Fi”), IEEE 802.16 (“WiMax”), etc. In various embodiments, all or a portion of networks 1106 may include the network infrastructure commonly referred to as the Internet. In other embodiments, networks 1106 and 1107 may be entirely contained within an enterprise and not directly accessible from the Internet. In certain embodiments, information may be exchanged over a virtual private network. In one embodiment, information is exchanged over the internet, but encrypted in such a way to make a private network not accessible from the rest of the internet.

In various embodiments, some users may be connected over a different network than other users. For example, as shown in FIG. 9, some users may be connected to cloud computing system 1101 over network 1106 and other users over network 1107. In some embodiments, one or more users are connected over a private network. For example, in the embodiment shown in FIG. 9, network 1106 may be a public network and network 1107 may be a private network.

In various embodiments, a user may communicate over systems in system 1100 from locations external to cloud computing system 1108. For example, a decision maker may communicate with users at a remote location by way of portable electronic devices 1122.

Portable electronic devices 1122 may be located anywhere, including a home, a government office, or any other location.

Computer systems may, in various embodiments, include components such as a CPU with an associated memory medium such as Compact Disc Read-Only Memory (CD-ROM).

The memory medium may store program instructions for computer programs. The program instructions may be executable by the CPU. Computer systems may further include a display device such as monitor, an alphanumeric input device such as keyboard, and a directional input device such as mouse. Computer systems may be operable to execute the computer programs to implement computer-implemented systems and methods. A computer system may allow access to users by way of any browser or operating system.

Computer systems may include a memory medium on which computer programs according to various embodiments may be stored. The term “memory medium” is intended to include an installation medium, e.g., Compact Disc Read Only Memories (CD-ROMs), a computer system memory such as Dynamic Random Access Memory (DRAM), Static Random Access Memory (SRAM), Extended Data Out Random Access Memory (EDO RAM), Double Data Rate Random Access Memory (DDR RAM), Rambus Random Access Memory (RAM), etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), television system or other device. In general, the term “computer system” may refer to any device having a processor that executes instructions from a memory medium.

The memory medium may store a software program or programs operable to implement embodiments as described herein. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (MFC), browser-based applications (e.g., Java applets), traditional programs, or other technologies or methodologies, as desired. A CPU executing code and data from the memory medium may include a means for creating and executing the software program or programs according to the embodiments described herein.

In various embodiments, data matching may involve field matching, data linkage, record linkage, or entity resolution. Data matching and error/inconsistency detection may, in various embodiments, be accomplished using processes that are probabilistic, deterministic, or combinations thereof In certain embodiments, heuristics are used for error/inconsistency detection.

As used herein, making an “assessment”, with respect eligibility, includes making a express determination of whether a person is eligible or ineligible for a benefit, but also includes other evaluations relating to eligibility. An assessment with respect to eligibility may yield, for example, a likelihood of eligibility (e.g., “likely eligible”, “likely not eligible”, or (“X % probability”), or that information needed to determine eligibility is missing.

As used herein, “client” means, in the context of a provider of products or services, a person who has received products or services, who is receiving products or services, or is seeking to acquire products or services. “Client” includes a person seeking or receiving a benefit (for example, a government benefit such as Medicaid assistance, Medicare assistance, CHIP, or Temporary Assistance to Needy Families (“TANF”), a tax credit, access to a potential employer, or insurance coverage) or assistance.

As used herein, “contact” refers to a contact by client or other person. Examples of modes of contacts include telephone calls and web chat inquiries. Contacts may originate from any person or group, including customers, subscribers, purchasers, enrollees, potential enrollees, general citizens, providers, health plans, or others, including anonymous callers. “Contacts” also includes program information or health plan enrollment activities.

As used herein, “recipient” includes an actual or potential recipient of a benefit, such as a payment under a government benefit program (for example, Medicaid, Medicare, TANF, or CHIP).

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Methods may be implemented manually, in software, in hardware, or a combination thereof. The order of any method may be changed, and various elements may be added, reordered, combined, omitted, modified, etc. Changes may be made in the elements described herein without departing from the spirit and scope of the invention as described in the following claims.

1. A method of ensuring program integrity in a benefit system, comprising:
accessing, from two or more data sources, a plurality of sets of data, wherein the data from at least one of the data sources relates to eligibility of at least one recipient to receive a benefit under a government program;
performing, electronic data matching using at least two of the data sources, wherein at least one of the data sources used for the data matching is a government data source;
making, by an eligibility review module in communication with the data broker module, based at least in part on the electronic data matching, one or more assessments relating to eligibility of the at least one recipient, generating, by the eligibility review module, based at least in part on at least one of the eligibility determinations, one or more recommendations on eligibility for the at least one recipient; and
displaying, in a consolidated view, results from the electronic data matching using two or more of the data sources.

2. The method of claim 1, wherein the electronic data matching is performed by a data broker sub-system, wherein the data broker sub-system comprises a data broker module implemented on one or more computer systems.

3. The method of claim 1, wherein making at least one of the assessments by the eligibility review module comprises the eligibility review module making a determination of whether at least one recipient is eligible or ineligible to receive the benefit.

4. The method of claim 1, further comprising determining a measure of program integrity based at least in part on the electronic data matching.

5. The method of claim 1, further comprising determining a measure of program integrity based at least in part on eligibility determinations by the eligibility review module for a group of recipients.

6. The method of claim 1, wherein performing the electronic data matching comprises requesting, by a data broker module, over a network, an electronic data matching result for at least one recipient under the government program.

7. The method of claim 1, further wherein the data sources are accessed through an adapter configured to access data from at least two of the data sources.

8. (canceled)

9. (canceled)

10. The method of claim 1, wherein the eligibility assessments are made on an on-going basis after eligibility grant and before a time of renewal.

11. The method of claim 1, wherein the eligibility assessments are used to make a determination for a passive renewal.

12. The method of claim 1, further comprising pushing to an evaluator, based on the electronic data matching, one or more recommendations indicating ineligibility of the at least one recipient.

13. (canceled)

14. (canceled)

15. The method of claim 1, wherein making the eligibility assessments comprises applying one or more filters for eligibility.

16. The method of claim 1,
wherein accessing, from two or more data sources, a plurality of sets of data, comprises:
accessing, by a benefit administration implemented on one or more computers, from a government entity database, information relating to one or more recipients that who have received or applied to receive a benefit from the government entity;
creating one or more cases associated with at least one of the recipients, wherein at least one of the cases relates to eligibility of at least one recipient to receive a government benefit; and
selecting at least one of the cases for assessment.

17. The method of claim 1, further comprising:
identifying, by the eligibility review module, one or more items of missing information relating to a case associated with at least one recipient, wherein at least one of the missing items affects eligibility of the at least one recipient ; and
generating, by a document processor module, an information request based at least in part on the data matching process; and
transmitting, by the document processor module, the information request to the at least one recipient.

18. (canceled)

19. The method of claim 1, further comprising:
identifying, by the eligibility review module, based at least in part on the data matching, an alternate program or benefit that the recipient may be eligible for; and
generating, in response to identifying the alternate program or benefit, a notice to the at least one recipient.

20. The method of claim 1, wherein the sets of data comprise information of two or more different data types, further comprising identifying at least one inconsistency between the sets of data of different data types, wherein at least one of the recommendations is based at least in part on at least one of the inconsistencies.

21. The method of claim 1, further comprising identifying, from the electronic data matching, one or more inconsistencies between self-attested data from the recipient and data from one or more other data sources.

22. The method of claim 1, further comprising providing, based at least in part on the electronic data matching, an indicator relating to the likelihood of eligibility of the at least one recipient.

23. A system, comprising:
an eligibility verification system implemented on one or more computer systems, wherein the eligibility verification system comprises an eligibility review module and a data broker module, wherein the data broker module is configured to implement:
accessing, from two or more data sources, a plurality of sets of data, wherein the data from at least one of the data sources relates to eligibility of at least one recipient to receive a benefit under a government program;
performing, by or at the direction of the data broker module, electronic data matching using at least two of the data sources, wherein at least one of the data sources used for the data matching is a government data source,
wherein the eligibility review module is configured to implement:
making, based at least in part on the electronic data matching, one or more assessments relating to eligibility of the at least one recipient,
generating, based at least in part on at least one of the eligibility determinations, one or more recommendations on eligibility of the at least one recipient, and
displaying, in a consolidated view, results from the electronic data matching using two or more of the data sources.

24. The system of claim 23, wherein the data broker module is implemented on data broker sub-system, wherein the data broker sub-system is operated at a separate location from the eligibility review module.

25. A non-transitory, computer-readable storage medium comprising program instructions stored thereon, wherein the program instructions, when executed on one or more computers, cause the one or more computers to implement an eligibility verification system configured to:
access, from two or more data sources, a plurality of sets of data, wherein the data from at least one of the data sources relates to eligibility of at least one recipient to receive a benefit under a government program;
perform, by or at the direction of a data broker module of the eligibility verifications system, electronic data matching using at least two of the data sources, wherein at least one of the data sources used for the electronic data matching is a commercial data source and at least one of the data sources used for the data matching is a government data source,
make, based at least in part on the electronic data matching, one or more assessments relating to eligibility of the at least one recipient,
generate, based at least in part on at least one of the eligibility determinations, one or more recommendations on eligibility of the at least one recipient, and
displaying, in a consolidated view, results from the electronic data matching using two or more of the data sources.

26-87. (canceled)
